(19) United States
(12) Patent Application Publication
(10) Pub. No.: US 2007/0038955 A1
(43) Pub. Date: Feb. 15, 2007

(54) Pen-based computer system having first and second windows together with second window locator within first window

(76) Inventor: Mitchell Van Nguyen, Westminster, CA (US)

Correspondence Address: Roy A. Ekstrand;Ste. 150, 3158 Redhill Ave., Costa Mesa, CA, 92626, US

(21) Appl. No.: 11/200,549

(22) Filed: Aug. 9, 2005

(51) Int. Cl. G06F 17/00

(52) U.S. Cl. 715/804; 715/541; 715/788

(57) ABSTRACT

A personal digital unit includes an image display together with a software-driven processor for managing the display. The display also includes a writing input capability. The display is divided into a more comprehensive window and a less comprehensive writing window. A locator rectangle is added to the image within the more comprehensive window and corresponds in proportionate position and size to the location and size of the writing window within the virtual page of the display.

### FIELD OF THE INVENTION

This invention relates generally to pen-based computer systems such as personal digital assistants, (PDAs), palm PCs, or pen tablets (collectively hereinafter referred to as “pen-based handheld computers or pen-based computers) and particularly to the use thereof in functions such as writing, drawing or editing.

### BACKGROUND OF THE INVENTION

Pen-based computer systems are well known and extremely popular in the art. The term “pen-based” is derived primarily from the extensive use of a stylus or “pen” to input information or manipulate the operation of a computer using touch screen selection and input. The stylus or pen is not generally a writing instrument but rather an elongated somewhat pointed object which is often housed within the computer unit itself and withdrawn for its interaction and use. Typically, the pen may be used to touch the display screen in order to perform functions of interactions such as selection of a displayed icon, movement of a scroll icon for image displacement or writing and mark up upon a displayed image.

While virtually any computer utilizing a touch screen and interacting stylus for input function may, in a sense, be described as “pen-based”, the term has generally become descriptive in the computer arts of a handheld relatively small computer device which initially was referred to as a personal digital assistant (PDA). A substantial variety of such pen-based computers have been provided in the art by manufacturers such as Palm, Sony, Handspring, ViewSonic, Hewlett-Packard, Casio, Compaq, Toshiba and others. Despite the large number of manufacturers producing pen-based handheld computers and the resulting variety of designs employed by each, all pen-based handheld computers generally include a small relatively flat generally rectangular housing within which a miniaturized computer circuit and memory is housed. A plurality of interactive buttons are usually supported upon the front surface of the housing and a typically rectangular interactive touch screen display is also provided. Additional circuitry within the housing allows the computer processor to interact with and manage the forming of display images upon the display screen and the reading of information applied via screen touching. A so-called pen which is actually a stylus is typically secured or received within a convenient holding position on or within the unit housing. The pen is generally elongated, usually cylindrical, and defines a relatively blunt point for screen touch action.

As low-cost microprocessor based computer and digital circuitry has become available in the market, such pen-based handheld computers have become increasingly popular and pervasive. Not surprisingly, a large number of system improvements and advances have also been provided by various practitioners in the art to move the product capabilities and efficiencies of pen-based computer systems forward to enhance product appeal. For example, U.S. Pat. No. 6,052,110 issued to Sciammarella et al sets forth DYNAMIC CONTROL OF ZOOM OPERATION IN COMPUTER GRAPHICS in which a circle is displayed on the screen and a cursor is moved within the circle to generate a zoom out in the direction of cursor movement or cursor movement outside the circle, a zoom out is generated in the direction of cursor movement.

U.S. Pat. No. 6,493,464 issued to Hawkins et al. sets forth a MULTIPLE PEN STROKE CHARACTER SET AND HANDWRITING RECOGNITION SYSTEM WITH IMMEDIATE RESPONSE which is capable of interpreting a special predefined set of single stroke glyphs. Each input stroke is identified with one of three categories, (1) pre-character modifier strokes, (2) character or symbol strokes, or (3) post-character modifier strokes. Each character stroke is independently recognized by the system processor and utilized in performing the display interpretation recognition and implementation.

U.S. Pat. No. 6,396,481 issued to Challa et al. sets forth an APPARATUS AND METHOD FOR PORTABLE HANDWRITING CAPTURE which combines a capture device such as a PDA, Notebook Computer, Set Top Box, Smart Television or other type of smart appliance having an image capture capability and built-in wireless transceiver together with an ink capture device. Communication between the ink capture device and the image capture device is achieved with conventional wireless technology.

U.S. Pat. No. 5,615,384 issued to Allard et al. sets forth a PERSONAL COMMUNICATOR HAVING IMPROVED ZOOM AND PAN FUNCTIONS FOR EDITING INFORMATION ON TOUCH-SENSITIVE DISPLAY which includes a casing for housing a cellular telephone, modem, and data processing system. Graphic image files are stored and can be selectively displayed on a touch screen display. A zoom function magnifies areas of a graphic image such as fax image that has been received and stored within the device. The image may be magnified by touching the to-be-magnified area on the screen. A pan function allows the user to shift the image within a viewing area. The user is able to pan the image by touching the display at an initial touch point and moving his/her finger keeping it in contact with the screen to shift the touch point to a new image location. Upon releasing the touch point, the image is redrawn in a new position corresponding to the change in position between initial and final touch points.

U.S. Pat. No. 4,633,436 issued to Flurry sets forth a REAL-TIME RUB-OUT ERASE FOR AN ELECTRONIC HANDWRITING FACILITY which includes a central processing unit, an all points addressable display and an electronic tablet and stylus. The handwriting facility simulates writing with a pen and pencil and paper. An electronic document is generated by periodically sending information to the central processing unit including the absolute location of the stylus in relation to the tablet. Each point is mapped to the display coordinate system and the points are stored in a point list. The handwriting facility is provided with a real-time rub-out erase feature wherein the handwriting facility is first set to erase mode and then the points in the point list to be erased are identified.

U.S. Pat. No. 6,476,831 issued to Wirth et al. sets forth a VISUAL SCROLLING FEEDBACK AND METHOD OF ACHIEVING THE SAME which provides real-time visual feedback to the user while scrolling in standard windowing environments. The visual scrolling technique makes use of a transient overlay which provides direct visual cues to the user about the new areas of the scrolled page that have been exposed to view by the scrolling action.

U.S. Pat. No. 5,616,089 issued to Miller sets forth a METHOD OF PUTTING which features the golfers dominant hand so that the golfer is able to improve control over the putting speed and direction.

U.S. Pat. No. 6,407,749 issued to Duke sets forth a COMBINED SCROLL AND ZOOM METHOD AND APPARATUS for simultaneously scrolling and zooming graphic data in a display device in response to pointing device action by user. The system alternates between zooming in and zooming out at preset rates in response to successive user actuation of a unique button set on the pointing device. While the button set remains actuated, the pointing device acts to pan the viewpoint.

Despite substantial advances and improvements of current pen-based handheld computer systems, their use in activities such as writing, drawing or marking requires further improvement to maximize efficiency. Such systems facilitate writing, drawing or marking the display to form or alter an image by repeatedly sensing the position of the pen point upon the touch screen display to derive a sequential set of pen point touch position. Thereafter, the system displays the locus of the pen point locations as the pen moves and connects each successive pen position in sequence of application to provide an image which is the locus of pen movements in a process similar to a “follow-the-dots” action. As a result, the user sees an image being formed virtually immediately behind the moving pen point upon the screen in a manner which appears to be writing or marking upon the screen by the user and which is often referred to as “digital ink”.

Currently, when interfacing in a graphical environment, often referred to as a page, that is much larger than the display screen, a scrolling feature is often implemented. Scrolling allows a user to navigate within a larger page by displaying a smaller portion thereof at a time. Scrolling allows a user to move a page up, down, or across a display screen, with new information appearing on the screen as old information disappears. Usually if a page is “scrollable” user interface objects such as scrollbars are also implemented. If a page is vertically scrollable because the page is vertically bigger than the display screen, a vertically running scrollbar is used. If a page is horizontally scrollable because the page is horizontally bigger than the display screen, a horizontally running scrollbar is used. Within these scrollbars there are also image objects known as scrollcars. Users often times refer to these image objects or scrollcars within their respective scrollbars to get a feel or a rough estimate as to what section of a page is being displayed. Usually along with being scrollable an image is less comprehensive, since the user is able to see only portion of the page. Being less comprehensive means that the user sees less of the entire page. Conversely, being more comprehensive means that the display screen or display window is showing more of a bird's eye view with greater encompassment of a particular page. As a page becomes bigger than the display screen, the scrollability increases and as a result the comprehensiveness decreases. Additionally, making a page one-way scrollable provides better comprehensiveness than making the same page scrollable both horizontally and vertically for reasons that will be further discussed below. Furthermore, for a given display screen area or display window a page being made only vertically scrollable results in what is displayed being more comprehensive than the same page being made both vertically and horizontally scrollable. Continuing on, if that same page is made to not be scrollable in any direction within the screen, meaning that the whole page is made to “fit” within the display window, what is being displayed will be more comprehensive the page being made only vertically scrollable as discussed above.

A display concept which is related to scrolling and comprehensiveness is found in the concept of “zooming” on a page. Currently, when interfacing with a page that is both vertically and horizontally larger than the display screen and that is made to be both vertically and horizontally scrollable, to improve the comprehensiveness or spatial awareness, a “zoom out” is performed on the page. That is, the page is “shrunken” on the display screen whereby the objects on the page are reduced in size while maintaining their relative positioning on the page. This will therefore display a greater proportion of the page and improve the overall spatial awareness. A zooming technique that is common among small limited sized devices is called “zooming to fit”. If the page has the same width to height ratio as the display screen, the user can zoom to fit the page on the display and have the top, bottom, left, and right edges of the page coincide with the borders of the screen. In this case, no scrollbars are necessary and maximum comprehensiveness is obtained. For cases, where the page does not have the same width to height ratio as the display screen, the zoom to fit feature shrinks the page so that only two parallel sides coincide with two parallel display screen borders so that the whole aspect in one direction is displayed. The entire aspect in the other direction may, or may not, be displayed depending on whether the zoomed out page is larger or smaller than the display screen in that direction. Stated simply, an image will be fully displayed when zoomed out provided that the aspect ratios (ratios of width to height) are the same for the image and the display. Thus, if the aspect ratios of the display and image are the same, the image may be zoomed out to provide a view of an image having a maximum comprehensiveness. Otherwise, if the vertical height of the resulting image happens to be taller than the vertical height of the display, only a portion that encompasses the complete horizontal aspect but not the complete vertical aspect may be displayed. In this event, making the resulting image vertically scrollable will allow a user to scroll to the other parts of the image.

Although handheld computers have become more powerful and versatile, they all suffer from having a limited sized screen. This is usually the result of being portable and mobile.

Because of this limitation, many applications written for small screen devices revert to using pages that are only vertically scrollable. Such pages are commonly referred to as being “mobile friendly” or “mobile version” pages. Implementing both vertically and horizontally scrollable pages often leads to a frustrating and annoying user experience especially when interfacing with devices having limited size screens.

During activities such as marking, writing, or drawing upon the image screen to produce graphical information (herein referred to as “digital ink”) a basic limitation arises due to the limited screen size on small handheld pen-based computer devices. Typically, when entering digital ink into a page that is both vertically and horizontally larger than the display screen or display window the user has very little spatial awareness. Gauging the portions of the scrollcars within their scrollbars can be helpful but is often times still inadequate, especially when the page is substantially larger than the display screen. In situations like this a user can easily become disoriented or somewhat “lost” within the page, having something similar to “tunnel vision” imposed on the user's view. Current systems attempt to address this problem by allowing the user to “zoom out” or alternatively “zoom to fit” the page on the display therefore improving a user's spatial awareness of the page. Unfortunately, in digital inking activities there is an obvious drawback in performing a “zoom out”. The resulting size reduction of the image caused by zooming out means that objects added subsequent to the zoom out at the writer's normal size, such as writing or drawings, are no longer proportional to the rest of the objects on the zoomed out image. The user may attempt to compensate for this effect and keep objects like writing or drawings proportional to the rest of the current objects on the page by writing or drawing in reduced size. However, depending upon the extent of zoom out, it may be impractical to or even impossible to write small enough to maintain proportionality. Therefore, there is a definite compromise required between, being able to write more naturally and more comfortably but having limited spatial awareness of the whole page or writing less naturally and less comfortably but having more spatial awareness of the whole page.

### SUMMARY OF THE INVENTION

Accordingly, it is a general object of the present invention to provide an improved pen-based computer interface system. It is a more particular object of the present invention to provide an improved image location system operable within a pen-based computer which facilitates virtual page location and improves spatial awareness, especially during the writing process.

A general objective of the current invention is to allow a user to write comfortably while having an improved spatial awareness of the current page so to reduce the feeling of being “lost” within the page and therefore present a more efficient more user friendly interface.

A further objective of the current invention is to utilize in essence two windows, one being more comprehensive than the other, meaning one displays a more “zoomed out” view of the current page. The preferred embodiment of the current invention is to have the first more comprehensive view display the full horizontal aspect of the page and have the window be vertically scrollable if necessary, for instance if the resulting height of the shrunken image of the page happens to be vertically taller than what the first window can in effect display. The second less comprehensive window is where the main interaction takes place such as the process of writing or drawing. The second window is both vertically and horizontally scrollable. The preferred embodiment of the present invention is to have information in both the first and second windows be dynamically updated. The primary purpose of the first window is to better inform the user of the location of the second window within the main page. The second window is where most of the typical interactions a user would normally do with an editable page take place.

In accordance with the present invention, there is provided a personal digital unit comprising: a display upon which one or more images may be displayed and upon which a user may write or mark to input further images to the unit; a processor within the unit for managing the display and inputs thereto; means for dividing the display into a first more comprehensive window and a second less comprehensive window; and means for displaying a locator rectangle image upon the first window, the locator rectangle being sized and positioned upon the first window in correspondence to the position and size of the second window relative to the entire page.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 sets forth a front view of a typical prior art personal digital assistance device suitable for use in practicing the present invention;

FIG. 2 sets forth an illustrative set of window diagrams showing the operation of the present invention system;

FIG. 3 sets forth a pair of diagrams illustrating the overall operation of the present invention system;

FIG. 4 sets forth a set of diagrams illustrating a sequence of images using non-dynamic updating of the present invention system;

FIG. 5 sets forth a set of diagrams illustrating dynamic updating in the present invention system;

FIG. 6 sets forth a set of images illustrating the window expandability and scrollability of the present invention system;

FIGS. 7, 8 and 9 show the definitions of the system variables used in the software implementing the present invention system;

FIGS. 10, 11, 12 and 13 set forth flow diagrams illustrating the operation of the present invention system using dynamic updating;

FIG. 14 sets forth a flow diagram of a non-dynamic updating system utilizing the present invention.

### DESCRIPTION OF THE PREFERRED EMBODIMENTS OF THE INVENTION

By way of overview, the present invention system is operable within an otherwise conventional personal digital assistant unit of the type often referred to in the art as “PDA”. The present invention system addresses the problem encountered by the user in writing or drawing or otherwise marking upon the unit display utilizing a pen stylus or other similar implement. The problem encountered relates that the user does not know where the writing being marked or entered upon the display screen is located with respect to the overall image maintained within the digital unit. This overall image is often referred to as the “virtual page”. In essence, this virtual page defines the entire image area available to the user. The problem is encountered because the image of the unit is displaying a small window portion of this overall virtual page. Thus, the writer is writing or drawing upon a small portion or window of the virtual page. To determine the location of the writing window upon the virtual page, the user typically looks at the scroll bars which are usually located on the outer edges of the window image and estimates the actual writing window position. This process is tedious and time consuming and is subject to substantial inaccuracies as it involves an estimate of window location.

The present invention addresses this problem by dividing the display upon the personal digital assistant unit into a pair of windows. The first window is a more comprehensive display and thus provides an image which shows more of the virtual page. As a result, this more comprehensive first window may be less detailed by showing a larger view of the virtual page.

In practice, the first window displays the entire horizontal dimension of the virtual page. It will be noted that on expandable units (that is PDA units having an expandable vertical display capability) the first window may be expanded to show the entire horizontal and vertical aspect of virtual page. In the event that the entire horizontal and vertical aspect of the page cannot be displayed, scrollbars may be used to make the window scrollable.

The second window utilized in the present invention system displays image objects larger relative to those of the first window and is thus less comprehensive (that is, displays a smaller portion of the virtual page). The second window is scrollable and may be expanded as well.

Finally, the present invention system provides a locator image referred to herein as a “locator rectangle” which is super imposed upon the image within the first window and which is a rectangle due to the convenience of using a locator which has a shape corresponding generally to the physical shape of the less comprehensive window. However, it will be apparent to those skilled in the art that a differently shaped locator such as a square, circle, ellipse etc may be used without departing from the spirit and scope of the present invention. This superimposed rectangle is proportionate in size and position to the second window relative to the virtual page. This rectangle moves within the first window as the second window moves upon the virtual page during scrolling. For a non scrollable and therefore all encompassing first window, the locator rectangle is always in view. However, when a scrollable first window is utilized, preferably only one way scrollable, this locator rectangle may not be fully in view depending on the location to which the first window is scrolled. In the preferred fabrication of the present invention, the image within the first window is dynamically updated during the writing process to enable the user to observe the location of both the rectangle upon the virtual page as well as the location of current writing within the virtual page. Alternatively, the updating of the first window may be triggered by an event such as a “pen-up” event. It should be noted that this locator rectangle may or may not be in view within the first window depending on what portion of the “zoomed out” page is in view in the first window.

Utilizing the present invention system, the user is able to judge the position of writing or drawings upon the second window image by observing the position of the rectangle within the first window. For a system that dynamically updates the “zoomed out” page within the first window, the user is able to judge the position of writing or drawings upon the second window image by observing the zoomed out virtual page within the first window. Additionally, the rectangle may be moved directly using the pen stylus and “dragging” the rectangle upon the first window or may be moved utilizing the scroll bars upon the PDA unit. It will be noted that without the advantages provided by the present invention system, the user must repeatedly take note of the positions of both the horizontal and vertical scroll bars of a window upon the unit in order to estimate the position of current writing upon the virtual page. While scroll hardware and capability in the host computer is not essential, it is preferable.

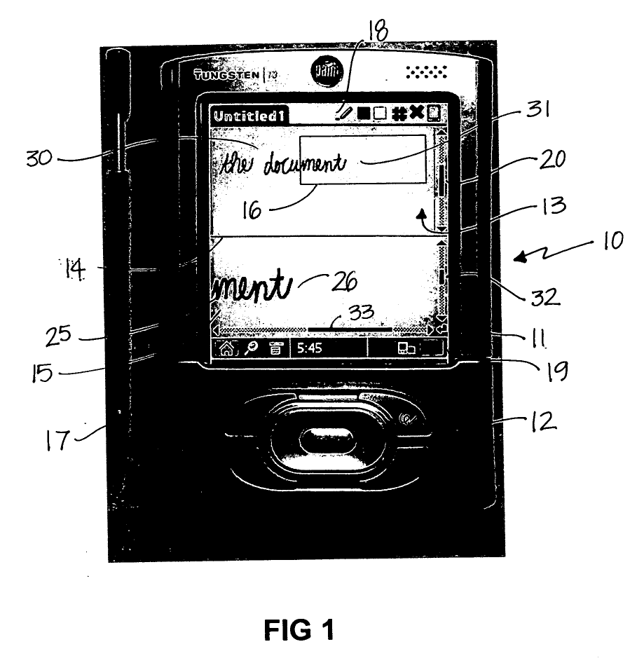

Initially, FIG. 1 sets forth a PDA device generally referenced by numeral 10 which is, apart from the present invention improved interface system installed therein, fabricated in accordance with conventional fabrication techniques. In the illustrative example set forth in FIG. 1, PDA 10 is a Palm Tungsten T3 device manufactured and distributed by Palm. Development tools, which may include CodeWarrior Development Studio for Palm OS version 9.3, PilRC Designer for Palm OS version 2.1.3.0, Palm OS 5 SDK (68K) R3 can be used in developing the required code for the embodiments of the system software set forth below. It will be apparent to those skilled in the art while the Palm device set forth in FIG. 1 provides a suitable operating environment for the present invention improved interface system, other devices having other software systems may be utilized without departing from the spirit and scope of the present invention. Thus the embodiment set forth in FIG. 1, utilizing Palm device 10 should be understood to be merely illustrative of a variety of similar devices.

More specifically, and with reference to FIG. 1, a typical PDA type unit having the present invention system implemented herein is shown in front view and is generally referenced by numeral 10. PDA 10 includes a housing 11 supporting a plurality of input buttons 12. Housing 11 further supports a display 13 upon which pluralities of icons 18 and 19 are displayed at the upper and lower edges respectively of display 13.

In accordance with the present invention, image display 13 is divided into a first upper window 14 and a second lower window 15. Upper window 14 includes a vertical scroll bar 20 while lower window 15 includes a vertical scroll bar 32. Window 15 further includes a horizontal scroll bar 33. In further accordance with the present invention, upper window 14 is a more comprehensive window and shows a portion of the zoomed out virtual page which PDA 10 maintains within memory as the full page. Thus, the zoomed out image of window 14 displays a substantially greater portion of the total virtual page. In the implementation of the present invention shown in FIG. 1, window 14 defines a horizontal width which corresponds to the width of the zoomed out virtual page together with a vertical height which comprises a portion of the vertical height of the zoomed out virtual page. Window 14 is a more comprehensive page viewing window which displays a portion of the zoomed out virtual page. In further accordance with the present invention, a locator rectangle 16 is also shown. It should be noted that the size of the zoomed out virtual page may be dependent of the horizontal width of window 14 and that locator rectangle 16 may not always be in view.

Lower window 15 is the designated window for user writing or marking and is less comprehensive relative to window 14. Window 15 is primarily used by the user in writing and marking and drawing etc upon the virtual page. For purposes of illustration, a portion of writing 25 is shown within window 15. This portion of writing 25 corresponds to the writing by the user utilizing stylus/pen 17 in a typical writing action which has reached end point 26 as the current position of the pen when the writing action stopped. In accordance with an important aspect of the present invention, rectangle 16 displayed within window 14 corresponds in relative size and relative position upon the zoomed out virtual page with the size and position of writing window 15 within the virtual page. Accordingly, examination of rectangle 16 reveals that rectangle 16 shows the portion of writing which has been written as writing 25 with end point 26 within window 15. In further accordance with the present invention, rectangle 16 also shows the position of the written portion viewable in window 15 upon the virtual document. Thus, the user is able to glance at window 14 and determine the corresponding location of writing window 15 upon the virtual page. This allows the user to immediately perceive how close to the edges the current writing is being placed upon the virtual page with greater accuracy and ease than utilizing a scrollbar. For this reason, scrollbars become optional. As a result, alternative means of scrolling may be implemented such as hardware scrolling apparatus.

The user is able to move window 15 upon the virtual page utilizing vertical scroll bar 32 and horizontal scroll bar 33. Because the width of the display within window 14 corresponds horizontally to the width of the zoomed out virtual page, no horizontal scrolling of window 14 is required. However, because the portion of the zoomed out virtual page shown within window 14 is less than the full vertical height of the zoomed out virtual page, scrolling vertically using scroll bar 20 is provided. Of importance with respect to the present invention and as is described below in greater detail, scrolling in either direction of window 15 causes rectangle 16 to move correspondingly upon the image shown in window 14. In this manner, the reference provided by rectangle 16 is maintained during scrolling.

In the example shown in FIG. 1, a dynamic update of the image within window 14 is utilized. That is to say, as the user impresses writing 25 upon window 15, a corresponding writing 30 appropriately scaled and positioned relative to rectangle 16 is simultaneously displayed. Alternatively, and as is also described below, the present invention may utilize a non-dynamic updating upon which a particular event is selected to implement the updating of the image within window 14 as the user writes. A typical updating event is provided by a “pen-up” event which corresponds to the user lifting the point of stylus/pen 17 and interrupting the writing action. In such case, this event triggers the implementation of an update of writing 30 within window 14. It will be apparent to those skilled in the art that the locations of windows 14 and 15 may be reversed without departing from the spirit and scope of the present invention.

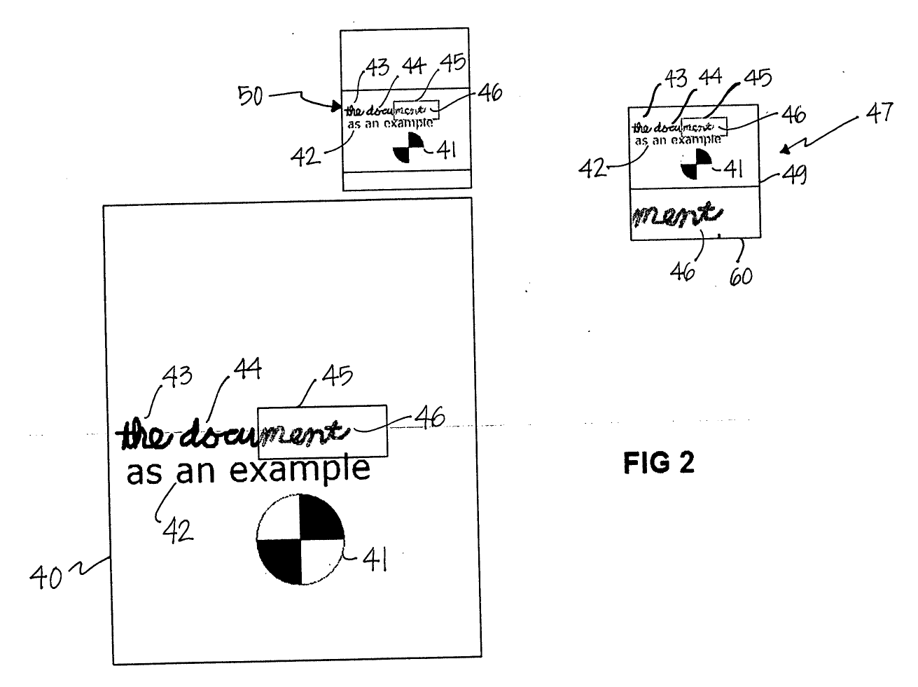

FIG. 2 sets forth an illustration of the operation of the present invention system as seen from image display. By way of example, a main virtual page 40 is shown having a symbol 41, a portion of text 42 together with a handwritten word 43. Also shown in page 40, is a portion of a handwritten word 44, the remainder of which is shown as current writing 46. In accordance with the present invention, a rectangle 45 is shown enclosing current writing 46.

In the operation of the present invention system, main page 40 is reduced in size to produce a corresponding reduced image 50. Reduced image 50 is essentially the “zoomed out” virtual page provided for the image displayed within window 49 of PDA display 47 and includes reduced images of symbol 41, text 42, and writings 43 and 44. Reduced image 50 further includes a proportionally reduced rectangle 45 within which a reduced current writing 46 is shown.

The PDA combined display 47 is shown in FIG. 2 and is formed by combining a portion of reduced image 50 within a more comprehensive window 49 with a portion of main page 40 within a less comprehensive writing window 60. In accordance with the present invention, writing window 60 is included within PDA display 47 and provides a full size image of current writing 46. As mentioned above, rectangle 45 is displayed upon image 50 in a corresponding size and position with respect to image 50 which replicates writing window 60 within main page 40. In this fashion, the present invention system designates a pair of windows in the manner described below in greater detail. One of which is a more comprehensive and typically less defined display window shown as window 49 together with a less comprehensive and typically more defined writing window shown as writing window 60. In further accordance with the present invention, a rectangle 45 is imposed upon reduced image 50 to show the position and relative size of writing window 60 within main page 40.

It will be apparent to those skilled in the art that an important aspect of the present invention is found in the provision of a more comprehensive window (window 14) and less comprehensive window (window 15). It will be equally apparent to those skilled in the art that image objects are displayed lesser in size within the more comprehensive window and greater in size within the less comprehensive window. Thus, the lesser image object size within the more comprehensive window and greater image object size within the less comprehensive window is a relative size relationship which may be obtained by several processes. In the example described herein, the image within the more comprehensive window (window 14) is a reduced portion of the virtual page while the image within the less comprehensive window (window 15) is a full-size portion. It will be apparent that the desired relative size relationship between window images may be obtained by displaying the image within the more comprehensive window (window 14) as a full size portion while enlarging the image within the less comprehensive window (window 15). By way of further alternative, both window images may be altered by reducing the image portion within the more comprehensive window and enlarging the image portion within the less comprehensive window. Accordingly, for purposes of convenience, the image within the more comprehensive window will generally be referred to herein as the “reduced” image or “smaller” image while the image within the less comprehensive window will be generally referred to herein as the “enlarged” image or “larger” image to denote this size relationship regardless of how it is achieved.

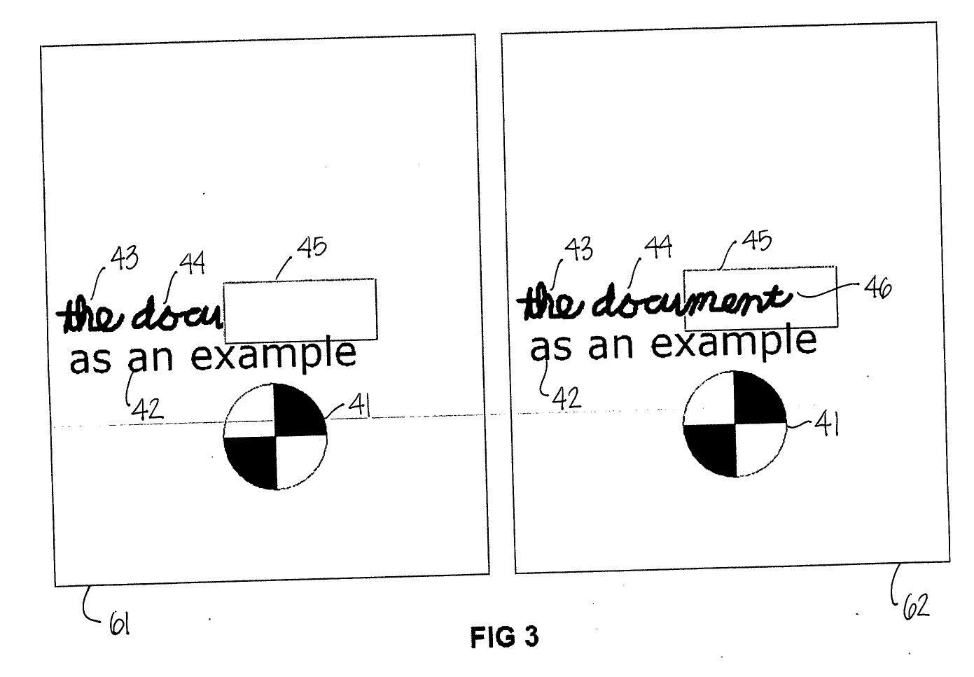

FIG. 3 sets forth the starting point and ending point of a series of transitional steps which are carried forward as the user writes upon the writing window and the process known as “updating” takes place. Updating is the process by which the handwritten material being applied by the user is combined with the existing image of the page itself. Furthermore and in particular with the present invention, updating also refers to the process of synchronizing information between a more comprehensive window and a less comprehensive window. Ultimately, this corresponds to the zoomed out virtual page and the virtual page respectively. Thus, FIG. 3 shows an initial zoomed out virtual page image 61 and an updated final zoomed out virtual page image 62 in side by side position for comparison. For purposes of explanation, the image shown on both images 61 and 62 utilizes the symbol and text material shown in main page 40 in FIG. 2 as well as reduced image 50 in FIG. 2. Thus, initial image 61 and updated image 62 both show the above-described images of symbol 41, text 42, handwritten word 43, handwritten word 44 and rectangle 45. In addition, to show the updating process having been completed, updated image 62 further includes current writing portion 46 shown within rectangle 45. As mentioned above, this updating process may take place either in a non-dynamic (event driven) process or alternatively, may be dynamically (real time) updated. In either event, the end result is the same whether dynamic or non-dynamic updating is utilized. The use of the present invention system in most applications favors a dynamic updating system in that the user is able to view the material being written in better perspective. However, both fall within the scope of the present invention system. An important advantage of dynamic updating is realized when a user begins writing/drawing within the writing window and continues that drawing beyond the boundaries of the drawing window. Digital ink will still be inputted within the virtual page and the user would have no way to trace the drawing ink but to look at the more comprehensive window for the “real time” dynamic rendering. This ability is unsupported with non-dynamic updating. Once the user has started writing, the user in a non-dynamic system, will have no way of knowing what the user is writing once the user leaves the boundaries of the drawing window. This is because the comprehensive window would not be updated until a pen up event.

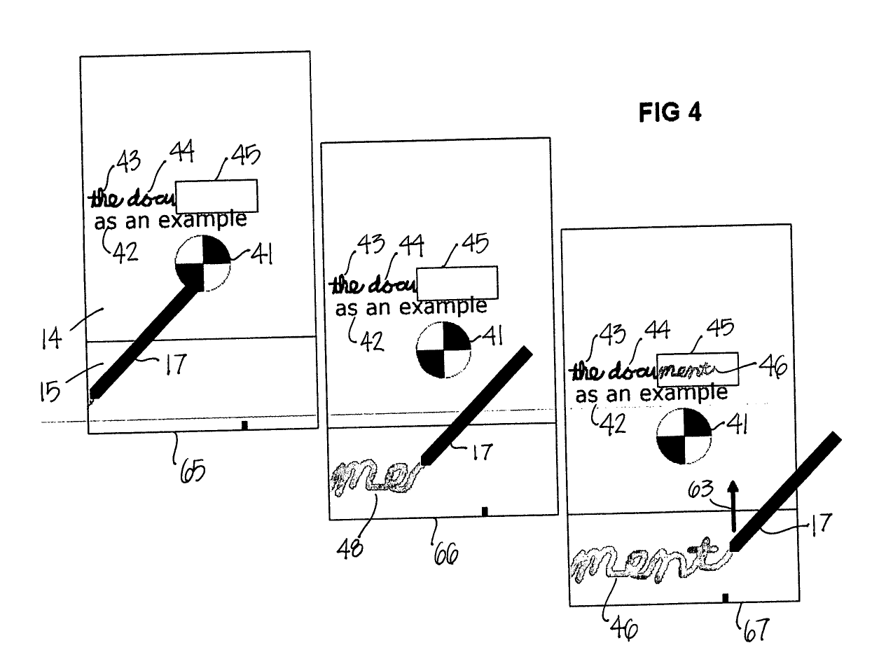

FIG. 4 sets forth a trio of sequential diagrams illustrating a non-dynamic updating process. Also shown in FIG. 4, are the relative positions of stylus/pen 17 (seen in FIG. 1) during the writing process. More specifically, FIG. 4 shows an initial image 65, an intermediate image 66 and an updated image 67. Initial image 65 corresponds to the display upon the host PDA (seen in FIG. 1) at the initiation of writing input by the user. Thus, an upper window 14 includes the above-described image shown in a more comprehensive view and thus the entirety of symbol 43, text 42, handwritten word 43, handwritten word 44 and rectangle 45 are shown. Initial image 65 further includes bottom window 15 which is the writing window described above. Accordingly, the user places the point of stylus/pen 17 against the desired portion of bottom window 15 and begins the writing activity. Of particular interest with respect to non-dynamic updating is the absence of any portion of current writing within rectangle 45.

As the user writes, an intermediate image 66 is formed which includes the image elements within window 14 and which further includes a written portion 48 produced as stylus/pen 17 is moved upon writing window 15. Once again, of particular importance with respect to non-dynamic updating, the image within rectangle 45 and the entire image within window 14 remains the same and is unchanged from initial image 65 despite the entering of written portion 48 due to movement of stylus/pen 17.

Finally, as the user completes written portion 48 forming current writing 46, the current writing within window 15 is updated within rectangle 45 and image within window 14 generally as the user lifts stylus pen 17 upwardly in the manner indicated by arrow 63. This upward movement of stylus/pen 17 comprises the above-mentioned “pen-up” event which is sensed by the system within PDA 10 and which is used to trigger an update within window 14 and particularly the image within rectangle 45. Thus, in this non-dynamic updating of the image within window 14, the update occurs each time a pen-up event is sensed.

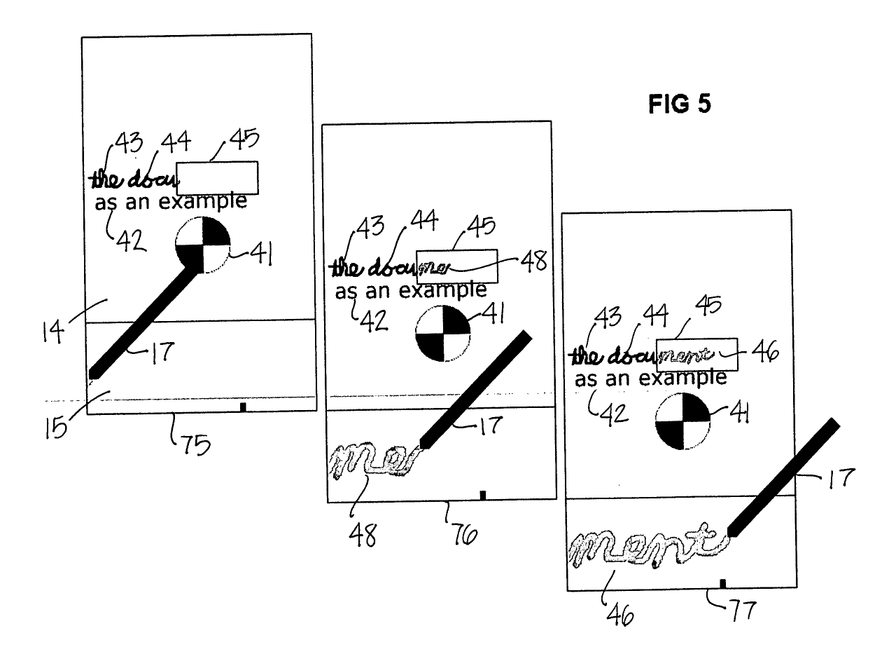

By way of contrast, FIG. 5 sets forth a set of sequential images which correspond to the action of the present invention system utilizing dynamic updating. It will be recalled that dynamic updating provides in essence a real time updating of the systems displayed images. More specifically, FIG. 5 shows an initial updated image 75, an intermediate updated image 76 and a finalizing updated image 77 depicting the sequential operation of a dynamic update within the present invention system. As mentioned above, the present invention divides the host PDA into a more comprehensive upper window 14 and a less comprehensive writing window 15. For convenience, the image shown in the sequential images of FIG. 5 remains the image utilized in the above examples. Thus, window 14 shows an image having a symbol 41, a text portion 42, a handwritten word 43 and a portion of a handwritten word 44. Window 14 also displays a rectangle 45 operative in accordance with the present invention. Image 75 also shows writing window 15 formed in accordance with the present invention. Thus, a stylus/pen 17 is positioned with its point touching the desired portion of writing window 15. Thereafter, as the user begins to write upon writing window 15, a written portion 48 is shown in intermediate image 76. In accordance with the dynamic update of the system shown in FIG. 5, a corresponding written portion 48 has also been displayed within rectangle 45 of window 14. Portion 48 will be understood to have been replicated within rectangle 45 in real time as the point of stylus/pen 17 is used to write upon window 15. As a practical matter, the present invention system will provide virtual dynamic updating by having the system update triggered by either a pen-down event, a pen-move event or a pen-up event. Thus, any movement or placement or removal of the point of stylus/pen 17 upon writing window 15 will cause an update of the image within rectangle 45 and window 14. In accordance with an advantage of the present invention, the user is also able to continue writing above or beyond window 15 while using the image in window 14 to navigate once the pen is down within window 15. The user is able to continue writing so long as the pen is within the display screen borders.

Image 77 shows the completion of this writing process and update as current word portion 46 is shown being formed upon window 15 and being simultaneously updated within rectangle 45 of window 14. Thus, a dynamic or real time updating has taken place.

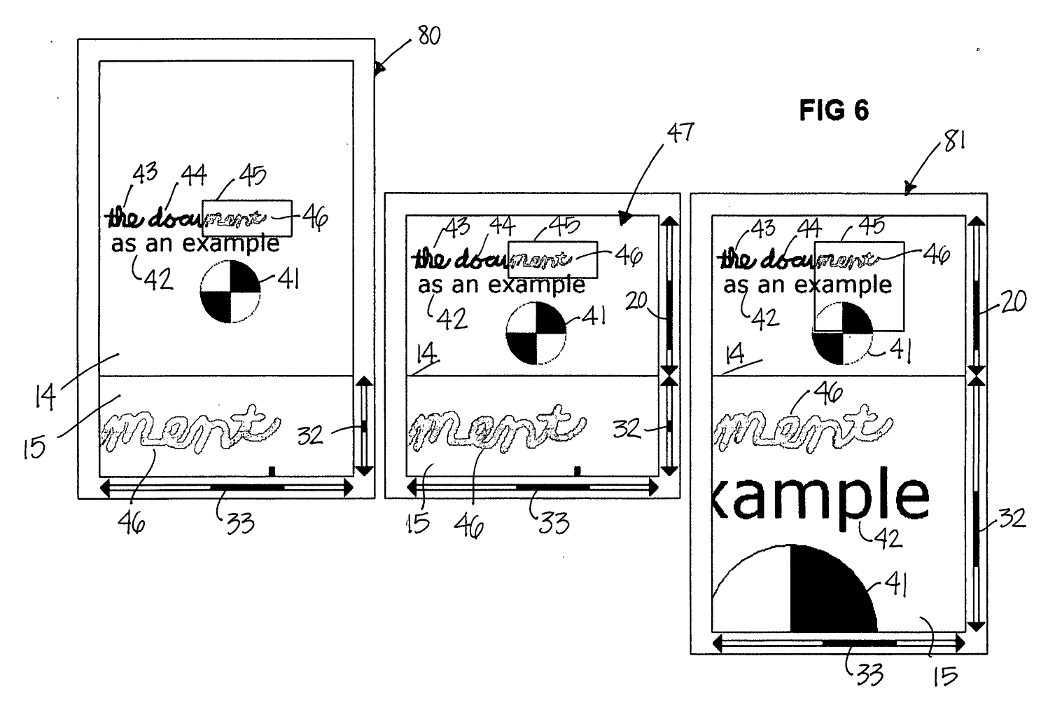

FIG. 6 sets forth the standard PDA display 47 shown in FIG. 1 in which neither the more comprehensive window (window 14) nor the less comprehensive writing window (window 15) is expanded. Image expansion refers to the capability provided by many PDA units in which the display area may be expanded or increased using either software expansion or hardware expansion. Hardware expansion is created by sliding one portion of the PDA unit upon another exposing an expanded display portion. Correspondingly, expansion may be implemented by software systems. By way of overview, image 80 shows the present invention system utilized in a host PDA having an expanded image capability. In image 80, more comprehensive window 14 has been expanded while less comprehensive writing window 15 remains unchanged. Conversely, in image 81, more comprehensive window 14 remains unchanged while less comprehensive writing window 15 is shown expanded. Of importance with respect to the present invention is the expansion which occurs within rectangle 45 as window 15 is expanded in image 81. Comparison of images 80 and 81 shows that the expansion of window 14 does not effect rectangle 45 since window 15 (which rectangle 45 depicts) remains unchanged. By comparison, image 81 shows the expansion of rectangle 45 which occurs due to the expansion of less comprehensive writing window 15. The choice of expansion of PDA displayed image area is a matter of user choice. Similarly, the present invention system is capable of utilizing this display expansion by either expanding the more comprehensive window (window 14) or the less comprehensive writing window (window 15).

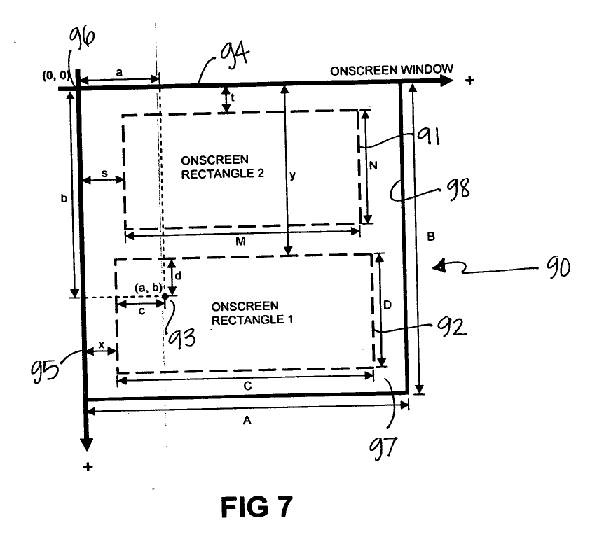

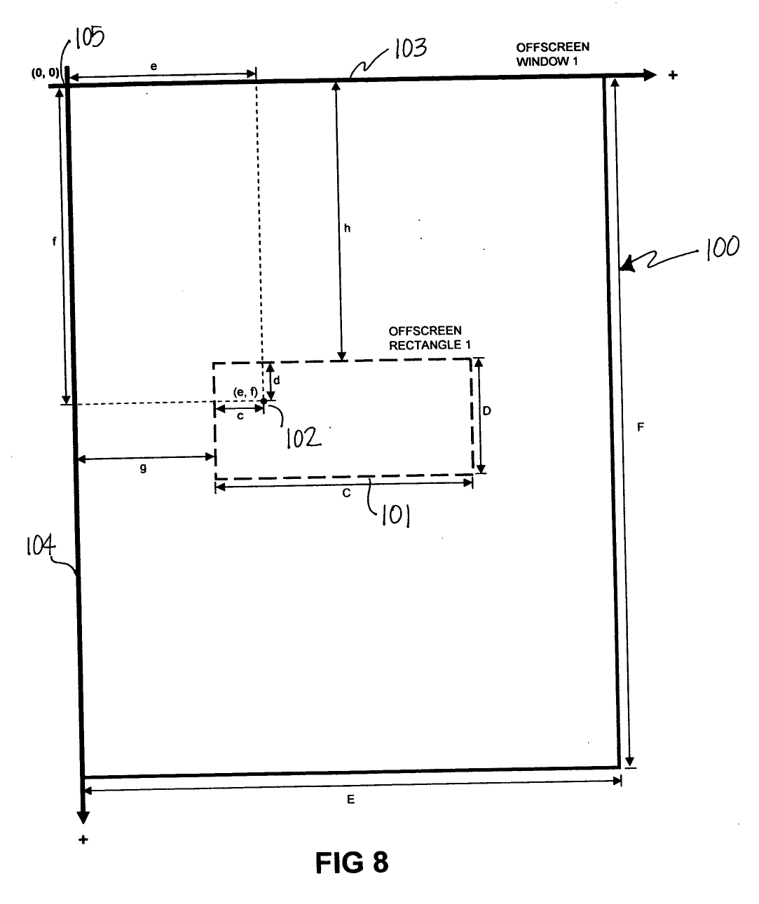

FIG. 7 sets forth an illustrative diagram of an onscreen display window and two display rectangles of the type which corresponds to touch-sensitive display screen 13 of computer 10 and is utilized in illustration in FIG. 1. For purposes of illustration in FIG. 7, the locating process for defining the location of a single pen point touch is utilized. It will be apparent to those skilled in the art, that the operation of the present invention system which will be illustrated in FIGS. 7 and 8 for this single sample point is applicable to each successive point location as the pen in contact with touch-sensitive display screen 13 (seen in FIG. 1) is moved in the above-described writing activity or other similar drawing or writing actions. This results from the operation of the processor within the computer 10 on a repetitive looped basis to form a continuous image as the pen writes upon the touch-sensitive display screen.

More specifically, FIG. 7 sets forth a diagram of touch-sensitive display screen 13 which defines an onscreen window 90 corresponding to the area within surrounding border 98. For purposes of assigning a location to each point within onscreen window 90 at which the user may touch the pen point, an origin 96 is established together with an X axis 94 which extends substantially horizontally and a Y axis 95 which extends substantially vertically. Thus, the maximum X axis coordinate for any point within onscreen window 90 is defined as A while the maximum Y axis coordinate for any point upon onscreen window 90 is defined as B, each point within onscreen window 90 is uniquely located by coordinates a, b. The area of onscreen window 90 is further separated into an onscreen rectangle 92 having outer dimensions C and D and an onscreen rectangle 91 having outer dimensions M and N which are selected to provide an outer area 97 upon onscreen window 90 which may be utilized for display of icons or other information as desired. If the display of surrounding icons or other image elements within an outer area is not required, the borders of onscreen rectangle 92 and onscreen rectangle 91 may be substantially coincident with borders 98 of onscreen window 90. In the illustration shown in FIG. 7, the onscreen rectangle 92 is distanced from X axis 94 by a distance y and from Y-axis 95 by a distance x and the onscreen rectangle 91 is distanced from X axis 94 by a distance t and from Y-axis 95 by a distance s.

Thus, in accordance with the utilization of onscreen rectangle 92 within onscreen window 90, an exemplary point location 93 is uniquely located by coordinates a, b and is further located within onscreen window 90 by distances a and b as shown. Alternatively, point 93 may be uniquely located by a second set of coordinate distances c and d referenced to the borders of onscreen rectangle 92. Of importance to note with respect to the present invention is the ability of the system to define each point of pen contact with display screen 13 by a single coordinate set which may then be converted in the manner described below in FIG. 8 to provide effective panning and scrolling and writing etc. Thus, each time the user touches pen 17 upon touch-sensitive display screen 13 within the onscreen window 90, a point is uniquely defined and assigned coordinates relative to the onscreen window 90 and onscreen rectangle 92. In addition, each time the system determines movement of the pen upon touch-sensitive display screen 13 to a new location, a further set of point location coordinates is defined. As mentioned above, successive points of contact as pen 17 is moved is utilized by the processor within computer 10 to “follow the dots” and write upon display screen 13 in a process which is often referred to as “digital ink”.

FIG. 8 sets forth a further diagram of the present invention interface system operation in which an offscreen window 100 corresponding to the virtual memory within the computer processor system is shown which is generally referenced by numeral 100. Offscreen window 100 is a virtual window and is not a window which is entirely viewable in the manner of onscreen 92 described above. Rather, offscreen window 100 is defined by the memory within the processor system. To avoid confusion, window 100 is referred to as offscreen to distinguish it from the onscreen display window provided by display 13. In accordance with the present invention operation described below, offscreen window 100 defines an origin 105 and an X-axis 103 together with a Y-axis 104. The maximum coordinate positions available within offscreen 100 are defined by distances E and F for x and y coordinates respectively.

Within offscreen window 100, an offscreen rectangle 101 is designated having sample point 102 positioned therein. It will be noted that offscreen rectangle 101 is identical in size and dimension to onscreen rectangle 92 but is located within offscreen window 100 by distances g and h. As shown above in FIG. 7, a sample point or location 102 is shown positioned within offscreen rectangle 101. However, offscreen rectangle 101 and the coordinates of sample point 102 are different from a, b set forth above for onscreen window 90. On the contrary, sample point 102 shows coordinates e, f which are related to origin 105 and offscreen window 100.

Thus, in accordance with the preferred operation of the present invention system, each point such as sample point 102 which is initially located within onscreen window 90 as described above in FIG. 7 must be converted to a second set of coordinates relative to the origin and axes of offscreen window 100. This conversion facilitates the panning and scrolling and writing, etc. operation described above which the present invention interface performs. Suffice it to note here that having established the allocated memory and virtual offscreen window 100 within the system memory, the present invention system is then able to position offscreen rectangle 101 therein and further to provide a converted relative set of coordinates for each point within onscreen window 90 shown in FIG. 7. The function of this conversion is to facilitate the movement of offscreen rectangle 101 in either direction within offscreen window 100 during panning, drawing or scrolling operations, etc.

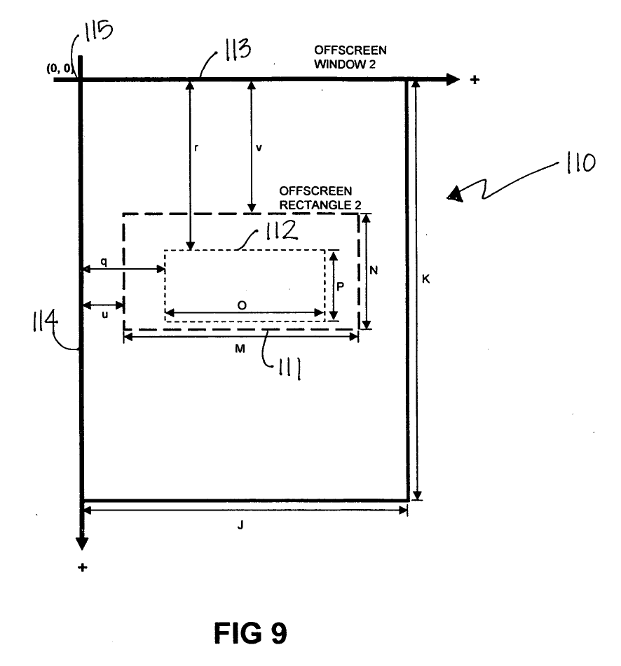

FIG. 9 sets forth a further diagram of the present invention interface system operation in which an offscreen window 110 corresponding to the virtual memory within the computer processor system is shown which is generally referenced by numeral 110. Offscreen window 110 is a virtual window and is not a window which is entirely viewable in the manner of onscreen 91 described above. Rather, offscreen window 110 is defined by the memory within the processor system. To avoid confusion, window 110 is referred to as offscreen to distinguish it from the onscreen display window provided by display 13. In accordance with the present invention operation described below, offscreen window 110 defines an origin 115 and an X-axis 113 together with an Y-axis 114. The maximum coordinate positions available within offscreen 110 are defined by distances J and K for x and y coordinates respectively.

Within offscreen window 110, an offscreen rectangle 111 is designated having locator rectangle 112 positioned therein. It will be noted that offscreen rectangle 111 is identical in size and dimension to onscreen rectangle 91 but is located within offscreen window 110 by distances u and v. It will also be noted that the position of locator rectangle 112 is dependent on the location of offscreen rectangle 101 above in FIG. 8 within offscreen window 100 also above in FIG. 8 and that locator rectangle 112 is located within offscreen window 110 by distances q and r. O and P represents the width and height of the locator rectangle 112 respectively and has the same ratio as the width C and height D of offscreen rectangle 101 above in FIG. 8. It will also be noted that the width J and height K of offscreen window 110 has the same ratio as the width E and the height F of offscreen window 100 above in FIG. 8. Finally, the ratio between width J and width E is equivalent to the ratio between height K and height F is equivalent to the ratio between width O and width C is the equivalent to the ratio between height P and height D is equivalent to the ratio between distance q and distance g is equivalent to the ratio between distance r and distance h.

It should be noted that offscreen window 110 is actually conceptual more than anything because it is essentially a running zoomed out image of offscreen window 100. Having the offscreen window 110, also known as the zoomed out virtual page, actually be declared to take up space in computer system memory is an efficiency for computer processors. If computer processing was fast enough, all aspects of offscreen window 110 can be determined and calculated in “real time” and therefore keeping a full running update of the offscreen window 110 in memory is not actually necessary.

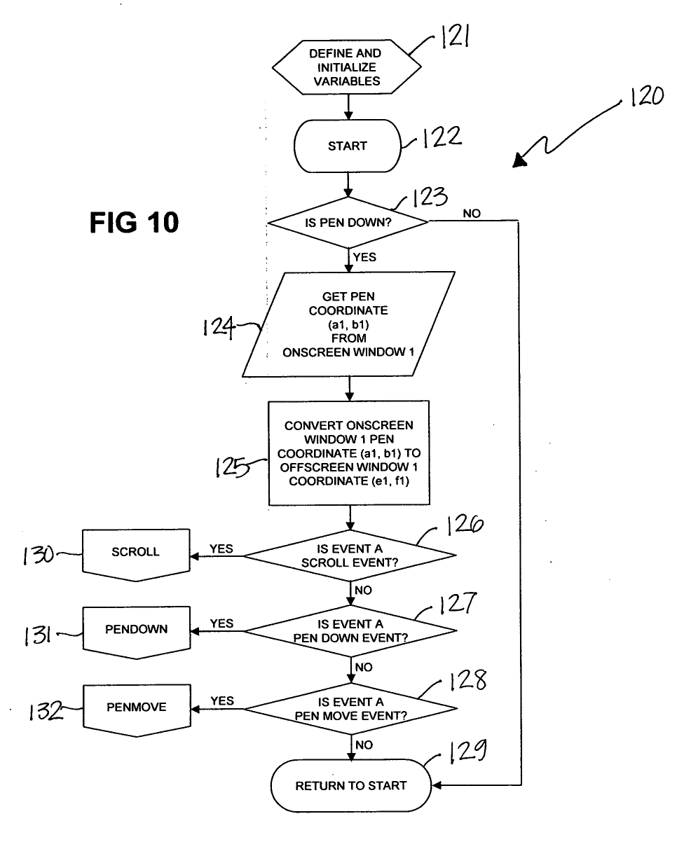

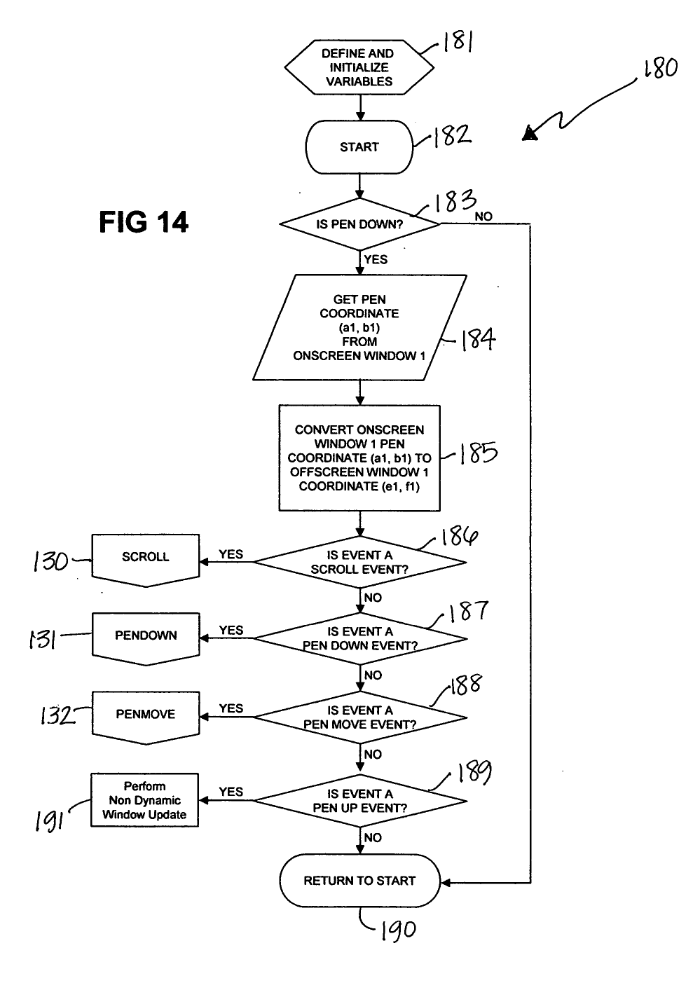

FIG. 10 sets forth a flow diagram of the basic overall operation of the present invention system generally referenced by numeral 120. Diagram 120 represents the operation of the present invention system in which dynamic updating is used. By way of comparison, it will be noted that in FIG. 14 a similar operationally diagram is set forth which depicts the system operation in a nondynamic update configuration.

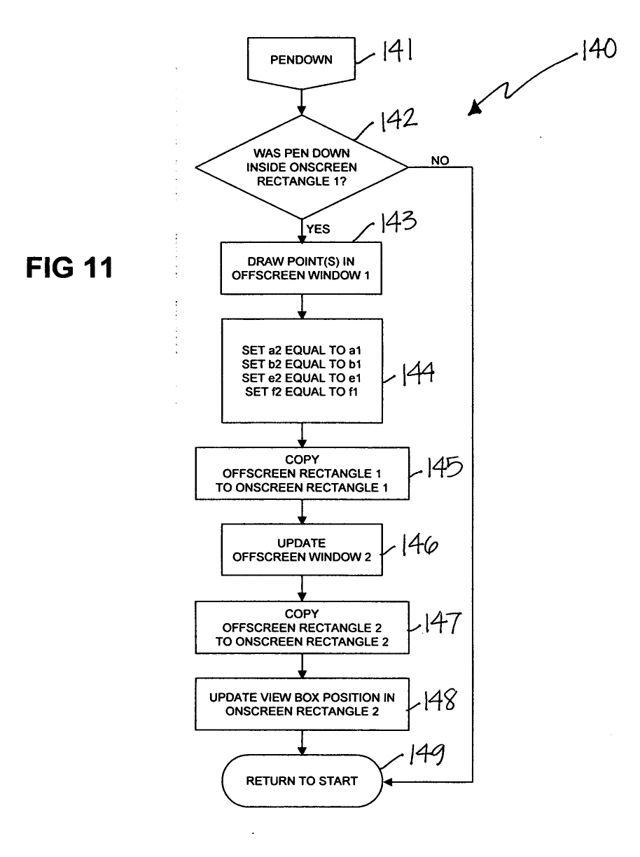

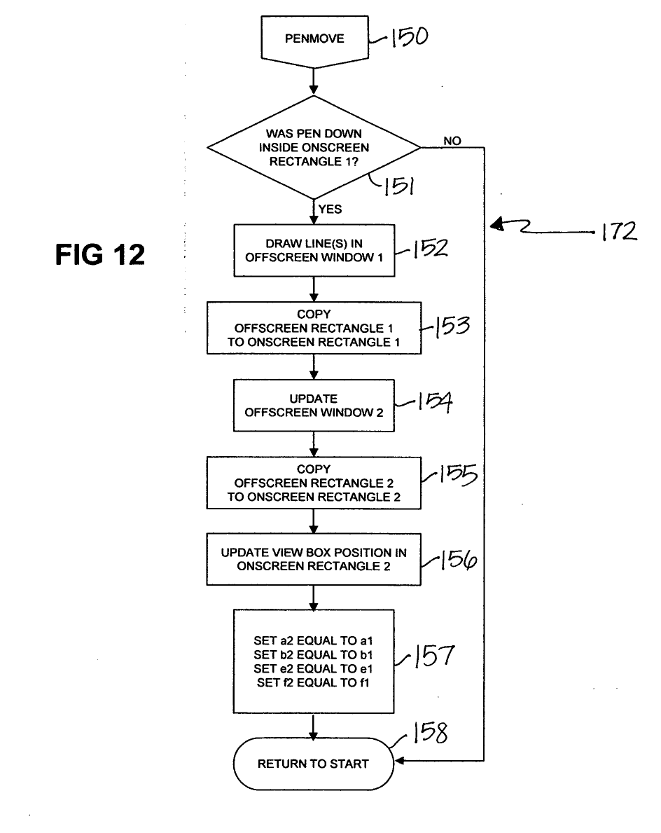

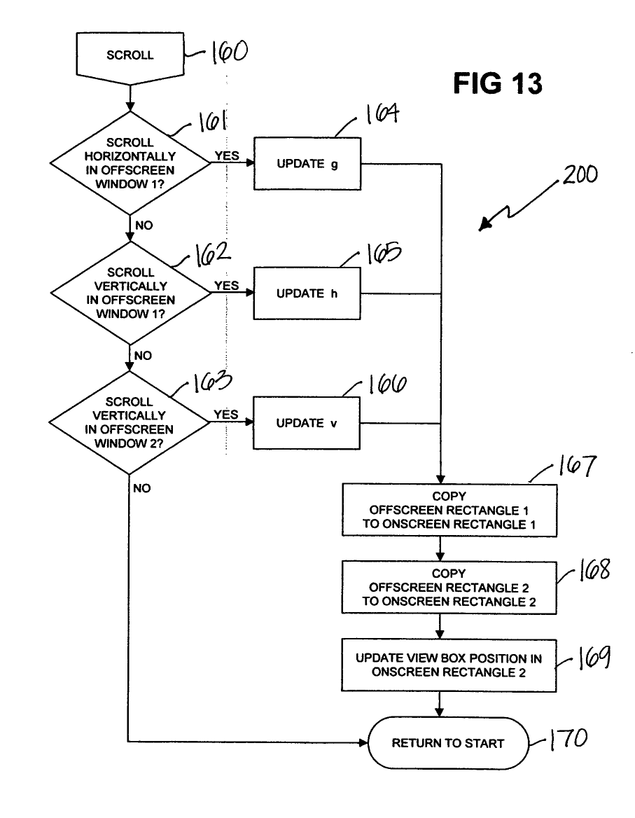

Returning to FIG. 10, at step 121, the system defines and initializes the system variables. The system variables are set forth in FIGS. 7, 8 and 9 described above. Once the system has defined and initialized its variables, the system moves to a start step 122 afterwhich a determination is made at step 123 as to whether a pen-down condition exists. This condition indicates the actual marking or writing upon the onscreen window 90 above in FIG. 7 by the user. In the event a pen-down event is not present, the system moves directly to step 129 in which a return to start function is implemented. If, however, a pen-down condition is determined at step 123, the system moves to step 124 in which the pen coordinates are determined from the onscreen window 90 in FIG. 7. Once the coordinates are determined, the system moves to step 125 in which the pen coordinates are converted to the offscreen window 100 in FIG. 8 coordinates (virtual page coordinates). Thereafter, a series of determinations are made at steps 126, 127 and 128 as to the character of the events occurring. At step 126, a determination is made as to whether a scroll event is being implemented. If a scroll event is being implemented, the system moves to the scroll operation at step 130 which is set forth below in FIG. 13 in greater detail. If, however, a scroll event is not taking place, the system determines at step 127 as to whether the event is a pen-down event. In the event a pen-down event has occurred, the system moves to step 131 and initiates the pen-down routine set forth below in FIG. 11. If, however, a pen-down event has not taken place, the system moves to a step 128 in which a determination is made as to whether the event is a pen-move event. If the event is a pen-move event, the system moves to step 132 and implements the operation for pen-move set forth below in FIG. 12 in greater detail. If, however, the event is not a pen-move event, the system moves to return to start step 129 completing the basic operation of the system.

FIG. 11 sets forth a flow diagram for the sequence of events taking place in the event a pen-down event is determined at step 127 in FIG. 10. The operation set forth in the flow diagram of FIG. 11 generally referenced by numeral 140 describes the sequence of events carried forward in response to a pen-down event (step 131 shown in FIG. 10). Pen-down event operation 140 is entered at step 141 in response to the determination at step 127 of a pen-down event (step 127 seen in FIG. 10). At step 142, a determination is made as to whether the pen-down was inside onscreen rectangle 92 in FIG. 7. In the event that the pen-down was not inside onscreen rectangle 92, the system moves directly to a return to start step 149. If, however, the pen-down was within onscreen rectangle 92, the system moves to step 143 in which the point or points produced by the pen-down are drawn within the offscreen window 100 in FIG. 8, also known as the virtual page. Thereafter, at step 144, the coordinates of the drawn points are saved into memory and set to the appropriate variables. Following the coordinate setting, at step 145 the content of offscreen rectangle 101 is copied to the onscreen rectangle 92. Thereafter, at step 146, a dynamic update of the offscreen window 110 is performed. Next, at step 147, the content of offscreen rectangle 111 following update is copied to the onscreen rectangle 91. At step 148, the view box (locator rectangle) position within onscreen rectangle 91 is updated. It should be noted that the routine at step 148 is directly related to the conditions set forth in FIGS. 7, 8, and 9 and particularly for locator rectangle 112 within offscreen window 110. Thereafter, the system returns to start at step 149.

FIG. 12 sets forth a flow diagram for the operation of the present invention system in response to a pen-move determination at step 128 shown in FIG. 10. The system operation in response to a determination of a pen-move event is generally referenced by numeral 172 and is shown in FIG. 12. Initially at step 150, the system enters the pen-move operation. Thereafter, at step 151, a determination is made as to whether the pen was initially placed down within the onscreen rectangle 92. If this is not the case, the system returns to start at step 158. If, however, the pen has been initially placed down within the onscreen rectangle 92, the system moves to step 152 in which the pen line or lines are drawn within the offscreen window 100.

Thereafter, the content of offscreen rectangle 101 is copied to the onscreen rectangle 92 at step 153. At step 154, a dynamic update of the offscreen window 110 is performed. At step 155, the updated content of offscreen rectangle 111 is copied to the onscreen rectangle 91. Thereafter, at step 156, the view box or locator rectangle position within the updated onscreen rectangle 91 is further updated to locate where locator rectangle 112 is within offscreen window 110. At step 157, the variables are updated and the system returns to start at step 158.

FIG. 13 sets forth a flow diagram of the system operation in response to a scroll event which is determined at step 126 shown in FIG. 10. The system response to a scroll event generally referenced by numeral 200 is initiated at step 160 as the scroll response begins. At step 161, a determination is made as to whether the scroll event is a horizontal scroll within the offscreen window 100. In the event that the scroll is not horizontal within the offscreen window 100, the system then determines at step 162 whether the scroll is a vertical scroll within the offscreen window 100. In the event it is determined at step 162 that the scroll is not a vertical scroll within the offscreen window 100, a determination is made at step 163 as to whether the scroll is a vertical scroll within the offscreen window 110. In the event the scroll is not a vertical scroll within offscreen window 110, the system returns to start at step 170.

In the event at step 161 a determination is made that the scroll is a horizontal scroll within offscreen window 100, the system moves to update the horizontal variable at step 164. In the event that a determination is made at step 162 that the vertical scroll is applicable to the offscreen window 100, the system moves to update the vertical variable therein at step 165. In the event a determination is made that the scroll is a vertical scroll within the offscreen window 110, the system updates the vertical variable at step 166.

Following updates of the appropriate variable at steps 164, 165 or 166, the system then moves to step 167 in which the content of offscreen rectangle 101 is copied to the onscreen rectangle 92. After step 167, the system moves to step 168 in which the content of offscreen rectangle 111 is copied to onscreen rectangle 91. Thereafter, at step 169, the view box or locator rectangle position within updated onscreen rectangle 91 is further updated to locate locator rectangle 112 within offscreen window 110. Following step 169, the system returns to start through step 170.

FIG. 14 sets forth a flow diagram of the system operation in a nondynamic update mode. Comparison of FIGS. 10 and 14 shows that the system operation in a nondynamic mode is basically the same as its operation in a dynamic mode with the difference being found in the implementation of an update of offscreen window 110 and essentially onscreen rectangle 91 being initiated in response to a selected event. As a practical matter, virtually any event may be utilized in triggering an update in the nondynamic update operation. For purposes of illustration, FIG. 14 shows an operational sequence generally referenced by numeral 180 in which a pen-up event has been selected as the event which triggers the offscreen window 110 and essentially onscreen rectangle 91 update. It will be apparent to those skilled in the art, however, that other system events may be selected as triggering events. By way of further overview, it will be noted by comparison of FIGS. 10 and 14 that the primary difference found in overall system operation is indicated by the entering of a nondynamic window update at step 191 in response to the selected triggering event, which in this case is a pen-up event, determined at step 189.

More specifically, system operation 180 begins at step 181 in which the system variables are defined and initialized. Thereafter, at step 182, operation is started. At step 183, a determination is made as to whether the pen is down. If not, the system moves directly to a return to start step 190. If the pen is down, however, the pen coordinates are obtained from the onscreen window 90 at step 184. At step 185, the onscreen window 90 pen coordinates are converted to offscreen window 100 coordinates. At step 186, a determination is made as to whether the event is a scroll event. If a scroll event is determined, the system moves to the scroll operation 200 (shown in FIG. 13) at step 130. If, however, a scroll event is not determined at step 186, the system moves to step 187 and determines whether the event is a pen-down event. If a pen-down event is present, the system moves to pen-down 131 and executes pen-down operation 140 (seen in FIG. 11) but omits steps 146, 147, and 148 because of the non-dynamic updating. If a pen-down event is not present, the system moves to step 188 to determine whether the event is a pen-move event. If a pen-move event is present, the system moves to the pen move operation 172 shown in FIG. 12 at step 132, but omits steps 154, 155 and 156 because of the non-dynamic updating. If, however, a pen-move event is not present, the system moves to a step 189 at which a determination is made as to whether the event is a pen-up event. If a pen-up event has occurred, the system moves to a nondynamic window update step 191. If the event is not a pen-up event, the system moves to a return to start step 190.

What has been shown is a novel system for use on a handheld personal digital unit which employs first and second windows within the unit display together with a locator rectangle displayed within the first window image indicating the position of the image displayed within the second window relative to the overall image. The first window provides a more comprehensive image which shows the entire horizontal dimension of the virtual page of a document. The second window is a less comprehensive but more detailed window which is used for writing and thus forms a writing window upon which the user is able to mark or write as desired. The writing or marking inputted by the user is repeated in proportionate location and size in the more comprehensive image of the first window. The second window indicator provides a rectangle upon the image of the first window which corresponds in position and proportionate size to the location and dimension of the writing window within the virtual page. In this fashion, the user is better able to visualize the position of the writing window upon the virtual page of the page while in the process of writing, drawing, scrolling, editing, viewing or the like.

The system provides for both dynamic and nondynamic updating of the more comprehensive window and eliminates the need for the user to constantly observe the scroll bar positions and make a rough determination of writing window position upon the virtual page.

The appendix attached hereto sets forth an exemplary source code Example_Rsc.h, Example_Rsc.rcp, Example.h, Example.c which may be used in conjunction with development tools, which may include CodeWarrior Development Studio for Palm OS version 9.3, PilRC Designer for Palm OS version 2.1.3.0, Palm OS 5 SDK (68K) R3 to generate object code which may further be installed into a Palm Tungsten T3 device to carry forward the present invention. Those skilled in the art will understand that modification can be made without departing from the spirit and scope of the present invention. It will equally be apparent to those skilled in the art that while the exemplary source code is shown written in C language, other languages may be used in carrying forward the present invention.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

That which is claimed is:

1. A personal digital unit comprising:
a display upon which one or more images may be displayed and upon which a user may write or mark to input further images to the unit;
a processor within said unit for managing said display and inputs thereto;
means for dividing said display into a first more comprehensive window displaying a more comprehensive image and a second less comprehensive window displaying a less comprehensive image, said more comprehensive image being smaller than said less comprehensive image; and
means for displaying a locator image upon said more comprehensive image within first window, said locator image being sized and positioned upon said more comprehensive image within said first window in general correspondence to the position and size of said less comprehensive image relative to said more comprehensive image within said first window.

2. The personal digital unit set forth in claim 1 wherein said locator is generally rectangular and wherein said first window displays an image which shows the horizontal width and a portion of the vertical height of a virtual page.

3. The personal digital unit set forth in claim 2 wherein said locator rectangle is positioned and sized within said first window in correspondence to the position and size of said second window upon said virtual page.

4. A method of controlling the display of images and image inputs to a personal digital unit, said method comprising the steps of:
providing personal digital unit having a display capable of displaying images thereon and receiving input marking and writing of images thereon;
dividing the display into a first more comprehensive window and a second less comprehensive window;
displaying a smaller first image on said first window showing the width and a portion of the height of a virtual page;
displaying a larger second image on said second window showing a portion of said first image; and
displaying a locator image on said first image which corresponds to the relative position of said second image on said virtual page which is proportional in size to the size of said second image.

5. The method set forth in claim 4 further including the steps of:
receiving writing or marking images on said second window and displaying them within said second image; and
copying a proportionately sized and located version of said writing or marking images within said first image.

6. The method set forth in claim 5 further including the step of:
performing repeated updates of said copied images within said first image.

7. The method set forth in claim 6 wherein said step of performing repeated updates includes the step of:
dynamically updating said copied images in real time.

8. The method set forth in claim 6 wherein said step of performing repeated updates includes the steps of:
establishing a trigger event;
detecting said trigger event; and
initiating a nondynamic update of said copied images when said trigger event is detected.

9. A personal digital unit comprising:
a display upon which one or more images may be displayed and upon which a user may write or mark to input further images to the unit;
a processor within said unit for managing said display and inputs thereto;
means for dividing said display into a first more comprehensive window within which a more comprehensive image is displayed and a second less comprehensive window within which a less comprehensive image is displayed and further images may be written or marked by a user, said more comprehensive image being reduced relative to said less comprehensive image;
means for displaying a locator image upon said first window, said locator image being sized and positioned upon said first more comprehensive image in correspondence to the position and size of said second less comprehensive image relative to said first more comprehensive image on said first window; and
means for displaying said further images written or marked by a user within said second less comprehensive window upon said second less comprehensive image and for dynamically updating said more comprehensive image to include said further images written or marked by a user as they are written or marked.

10. A method of controlling the display of images and written or marked image inputs to a personal digital unit, said method comprising the steps of:
providing personal digital unit having a display capable of displaying images thereon and receiving input writing or marking of written or marked images thereon;
dividing the display into a first more comprehensive window and a second less comprehensive window;
displaying a reduced first more comprehensive image on said first window showing the width and a portion of the height of a virtual page;
displaying a second enlarged less comprehensive image on said second window showing a portion of said first image;
displaying a locator image on said first image which corresponds to the relative position of said second image on said virtual page which is proportional in size to the size of said second image;
displaying said written or marked images upon said second less comprehensive image as being written or marked; and
displaying said written or marked images upon said first more comprehensive image in a dynamic updating process.
